(19) United States
(12) Patent Application Publication
(10) Pub. No.: US 2023/0358109 A1
(43) Pub. Date: Nov. 9, 2023

(54) Method and Apparatus for Conditioning of Fluids and Reduction of Environmental Waste Disposal

(71) Applicants: Jeffrey A. Reddoch, Eunice, LA (US); Jeffrey A. Reddoch, II, Lafayette, LA (US)

(72) Inventors: Jeffrey A. Reddoch, Eunice, LA (US); Jeffrey A. Reddoch, II, Lafayette, LA (US)

(21) Appl. No.: 18/312,310

(22) Filed: May 4, 2023

Related U.S. Application Data
(60) Provisional application No. 63/338,712, filed on May 5, 2022.

(51) Int. Cl. E21B 21/06; B04B 11/02; B04B 5/12

(52) U.S. Cl. CPC E21B 21/065; B04B 11/02; B04B 5/12; B04B 2005/125

(57) ABSTRACT

An apparatus for conditioning drilling fluid on a drilling rig or other location having a housing defining at least one inner chamber having a fluid inlet and a fluid outlet. At least one rotating ring, which is operationally attached to a drive shaft, and at least one stationary ring, are positioned in the inner chamber. The rotating ring further has movable geometric protrusions extending therefrom, while the stationary ring has stationary geometric protrusions extending therefrom. Selective rotation of the drive shaft causes the rotating ring and attached geometric protrusions to rotate. Drilling mud is pumped through the housing and is mixed at a very high rate without shearing or degrading entrained solids in the mud.

### CROSS REFERENCES TO RELATED APPLICATION

This application claims priority of U.S. PROVISIONAL PATENT APPLICATION Ser. No. 63/338,712, filed May 5, 2022, incorporated by reference herein.

### STATEMENTS AS TO THE RIGHTS TO THE INVENTION MADE UNDER FEDERALLY SPONSORED RESEARCH AND DEVELOPMENT

None

### BACKGROUND OF THE INVENTION

### 1. Field of the Invention

The present invention pertains to method and apparatus for conditioning drilling fluids and fully utilizing chemicals that are typically not yielded, thus substantially improving certain fluid properties. More particularly, the present invention comprises a device having at least one rotating smooth protrusion which removes opposing electrical forces within the fluid (including surface tension) so that chemicals in the fluid can more uniformly mix with the fluid.

### 2. Description of the Related Art

Drilling fluids (including, but not limited to, “drilling muds”) are typically used in connection with drilling of oil and gas wells that extend into subterranean formations in the earth's crust, as well as other operations conducted in said wells. Such drilling fluids provide a number of important benefits during such drilling or other operations. By way of illustration, but not limitation, such benefits can include the following: (1) cooling and lubricating of drill bits and/or other down hole equipment used in a wellbore; (2) transporting rock cuttings and/or other materials to a well's surface; (3) suspending rock cuttings and/or other materials during periods when pumping of drilling mud in a wellbore is stopped; and (4) providing hydrostatic head pressure to balance/control subsurface pressures.

Characteristics of said drilling fluids can have a significant impact on the overall quality and performance of drilling or other operations conducted in a wellbore. In many cases, various additives, chemicals and/or other materials can be added to drilling fluids. Frequently said additives, chemicals and/or other materials are designed to control properties of such drilling fluids, and to maintain said properties within desired parameters in order to improve performance of said drilling fluids.

Improved drilling fluid characteristics typically means better overall performance of drilling or other downhole operations. For example, improved drilling fluid characteristics can improve wall cake in a well bore, reduce or eliminate well caving or other wellbore integrity problems, and lower equivalent circulating density (which can cause undesirable loss of drilling mud into downhole formations). When drilling muds exhibit lower equivalent circulating density, surface mud pump pumping rates can be increased to improve wellbore cleaning and drill bit penetration rate which, in turn, reduces time and expense associated with such drilling operations. Moreover, the cutting efficiency of a rotary drill bit can be dramatically impacted by density, viscosity, solids content and other characteristics of drilling mud in a well.

Frequently, the condition of drilling mud can degrade over time as it is circulated within a wellbore and used in connection with drilling operations. Attempts have been made to condition (or recondition) drilling fluids—including, without limitation, while said drilling fluids are being used on a drilling rig—in order to control (or improve) certain key characteristics of the drilling fluids. However, these attempts have frequently been ineffective or yielded unsatisfactory results.

Thus, there is a need for an improved drilling fluid (re)conditioning system that is compatible with existing drilling rig equipment and surface equipment. Said improved drilling fluid system should treat and/or condition drilling fluids to enhance and control characteristics of said drilling fluid, while facilitating improved performance of well operations including, without limitation, drilling operations.

### SUMMARY OF THE PRESENT INVENTION

The present invention generally comprises an apparatus for conditioning and/or otherwise improving desired characteristics of drilling fluid on a drilling rig or other location, which is sometimes referred to herein as a “reactor”. In a preferred embodiment, the fluid conditioning apparatus of the present invention generally comprises a housing defining an inner chamber. A fluid inlet permits drilling fluid to flow into said inner chamber of said housing, while a fluid outlet permits drilling fluid to flow out of said inner chamber of said housing.

Disposed within said inner chamber of said are disposed at least one stationary ring and at least one one rotating ring. Said rotating ring further comprises a plurality of extended geometric protrusions (“gp”). As said at least one rotating ring spins, said at least one stationary ring and said at least one rotating ring pass by each other, with varying distance dimensions between each other (resulting from the number of gps, configuration and shape(s) of the gps, and the gap or space between the gp end and the opposing ring. A pipe segment can be strategically positioned to direct the fluid to flow to the gp, while preventing fluid from flowing around the fluid conditioning mechanism.

A mechanical fluid pressure seal is typically situated internally or externally relative to said “reactor” apparatus. Said mechanical fluid pressure seal can be selectively removed from outside of the reactor, so that said housing of said reactor does not need to be opened to access said inner chamber. Furthermore, in a preferred embodiment, said reactor housing is welded with stainless steel that cannot be easily cut with a torch. Alternatively, stainless steel mechanical fasteners can be used to seal said housing, thereby requiring a specialized tool to access said inner chamber of said reactor.

In a preferred embodiment, a plurality of posts (such as screws) or other protrusions extend into the inner chamber of the reactor housing at desired positions around the outer circumference of said rotating ring. Said protrusions serve to center said rotating ring, so that a pump shaft connected to said rotating ring can be removed from said rotating ring, while said rotating ring itself remains centered within said inner chamber of said reactor housing.

A pipe or other member can be strategically placed to direct fluid flow path through said inner chamber of said reactor (typically a circumference path), but not through the middle of said inner chamber of said housing wherein fluid treatment action can be bypassed. No shearing or cavitation occurs, as the geometric shapes do not shear the fluid. Further, the reactor housing and other components do not degrade from cavitation.

At least one camera and sensors can be strategically placed to detect theft, as well as sensors to selectively measure desired variables and reactor performance (such as, for example, temperature inside and outside of the reactor housing, rpm, and other variables). Measured data can be transmitted to distant location(s), such as an office for real-time monitoring of the performance of the apparatus. Such monitoring, together with monitoring of an active mud system, can be used to selectively adjust the device, while also alerting personnel when the apparatus requires maintenance and/or replacement.

The apparatus of the present invention can include at least one centrifugal pump to feed drilling fluid to said reactor from a rig's active mud system. In a preferred embodiment, an electric motor is not coupled directly to the reactor—thus, in the event of a failure of a mechanical fluid pressure seal, said electric motor is not damaged or destroyed.

The present invention reduces or eliminates surface tension in the mud, allowing ultrafine solids to clump together, so that centrifuges can remove them, which constitutes a major achievement in the reduction of cost and waste to the environment. With conventional solutions, drilling fluids must be diluted substantially to make the fluids usable for drilling operations, which can be wasteful, inefficient and expensive.

### BRIEF DESCRIPTION OF THE ANNOTATED DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

Further, the drawings constitute a part of this specification and include exemplary embodiments of the technology. It is to be understood that in some instances, various aspects of the invention may be shown exaggerated or enlarged to facilitate an understanding of the invention. Therefore, the drawings may not be to scale.

FIG. 1A depicts a graphical representation of certain characteristics (including particle size distribution) for a drilling fluid.

FIG. 1B depicts a graphical representation of certain characteristics (including particle size distribution) for said drilling fluid after being treated using the fluid conditioning apparatus of the present invention.

FIG. 2 depicts a schematic view of the fluid conditioning apparatus of the present invention incorporated within a mud system of a conventional drilling rig.

FIG. 3 depicts a side view of the fluid conditioning apparatus of the present invention.

FIG. 4 depicts an end view of the fluid conditioning apparatus of the present invention.

FIG. 5 depicts a schematic view of a control system for the fluid conditioning apparatus of the present invention.

### DETAILED DESCRIPTION OF A PREFERRED EMBODIMENT

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

As previously discussed, improved drilling fluid characteristics typically translate into better drilling performance; such improved performance can take the form of better wall cake in well bores, less well caving or other wellbore integrity problems, and lower equivalent circulating density (which can cause undesirable loss of drilling mud into downhole formations). When drilling muds exhibit lower equivalent circulating density, surface mud pump pumping rates can be increased which often results in better cleaning of a wellbore and higher drill bit penetration rate which, in turn, reduces time and expense associated with such drilling operations.

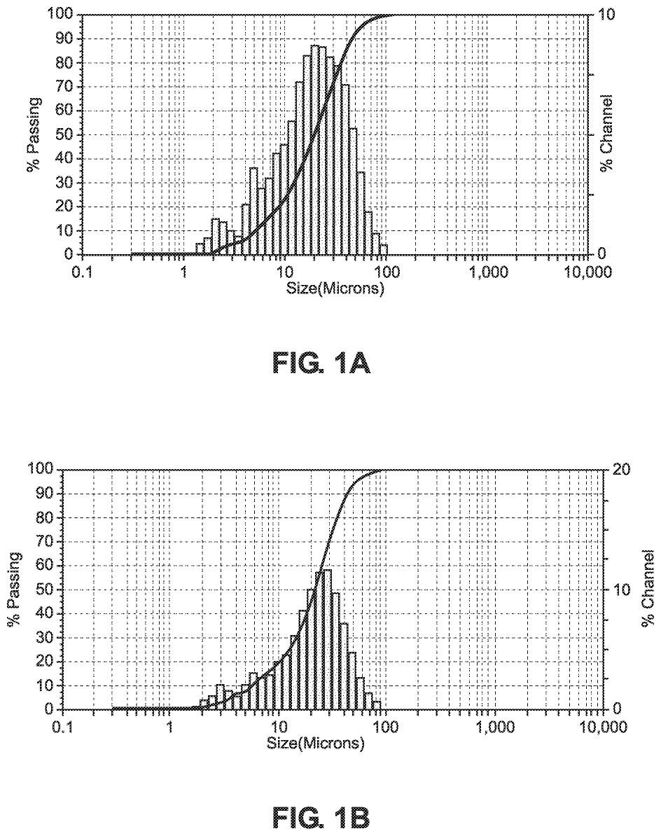

The present invention aggressively mixes drilling fluids without shearing or other potentially harmful effects. FIG. 1A depicts a graphical representation of certain characteristics (including particle size distribution) for a drilling fluid, such as untreated drilling fluid and/or drilling fluid that has not been used within a well. As depicted in FIG. 1A, the drilling fluid sample contains approximately 23.65% of the total sample volume of solids less than 10 microns in size.

FIG. 1B depicts a graphical representation of certain characteristics (including particle size distribution) for said drilling fluid after being treated using the fluid conditioning apparatus of the present invention. As depicted in FIG. 1B, the volume of solids less than 10 microns is substantially reduced compared to the fluid analysis shown in FIG. 1A.

Based on the sample comparison between FIGS. 1A and 1B, the present invention removed substantially all of the ultra-fine particles from said fluid. Such ultra-fine particles typically cause poor drilling mud performance and related problems, while adding dilution costs and chemical requirements. Further, the comparison illustrates that the present invention does not degrade solids, but rather increases the ability of conventional equipment (such as, for example, centrifuges and other equipment) to remove such ultra-fine solids.

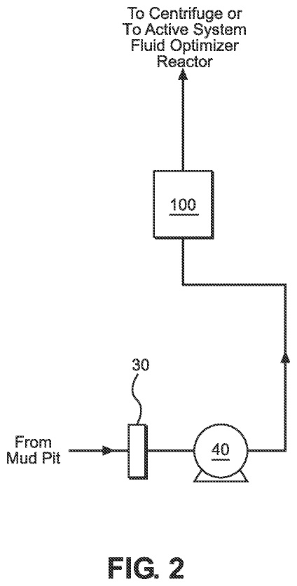

FIG. 2 depicts a schematic view of the fluid conditioning apparatus 100 of the present invention incorporated within a conventional active mud system of a drilling rig or other similar installation. As depicted in FIG. 2, drilling mud or other fluid can be diverted from a mud pit or other take point of a rig's active mud system. Said drilling mud or other fluid can flow through optional screen 20 to filter out large sized solids and/or other debris. Said drilling mud or other fluid can then be diverted to an optional pump 40 (such as a centrifugal pump) which, in turn, can pump said drilling mud or other fluid through fluid conditioning apparatus 100 of the present invention as more fully discussed herein. Drilling mud or other fluid leaving said fluid conditioning apparatus 100 can be directed to a conventional centrifuge or other conventional fluid conditioning/solids removal equipment, or sent back the rig's active mud system. Notwithstanding the foregoing, it is to be observed that the configuration depicted in FIG. 2 should be seen as an illustrative example, and is not intended to be limiting in any manner.

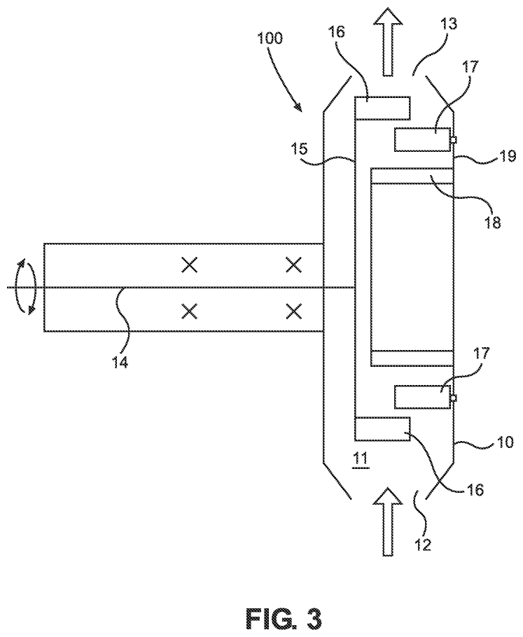

FIG. 3 depicts a side view of fluid conditioning apparatus 100 of the present invention. In a preferred embodiment, said fluid conditioning apparatus 100 generally comprises an apparatus for conditioning drilling fluid on a drilling rig or other location, which is sometimes referred to herein as a “reactor”. Said fluid conditioning apparatus 100 of the present invention comprises a housing 10 defining at least one inner chamber 11. Fluid inlet 12 permits drilling fluid to flow into said inner chamber 11 of said housing 10, while fluid outlet 13 permits drilling fluid to flow out of said inner 11 chamber of said housing 10.

Within said inner chamber 11 of said housing 10 is disposed at least one rotating ring 15 which is operationally attached to drive shaft 14, as well as one stationary ring 19. It is to be observed that rotation of said drive shaft 14 around its longitudinal axis, in turn, causes rotation of rotating ring 15.

Still referring to FIG. 3, said rotating ring 15 further comprises a plurality of movable geometric protrusions or “mgps” 16 extending from said rotating ring 15. A motor or other device (not pictured in FIG. 3) can apply torque forces to drive shaft 14, thereby causing said drive shaft 14 to rotate. Stationary ring 19 has a plurality of stationary geometric protrusions or “sgps” 17 extending from said stationary ring 19 in general proximity to mgps 16.

Selective rotation of said drive shaft 14 causes rotating ring 15 (as well as mgps 16 attached thereto) to rotate. Said at least one rotating ring 15 (and attached mgps 16) rotates relative to stationary ring 19, with varying distance dimensions between rotating ring 15 and stationary ring 19, as well as between mgps 16 and sgps 17. It is to be observed certain variables can be selectively adjusted, which can affect the performance of the fluid conditioning apparatus 100 of the present invention including, without limitation, the following: the number of mgps 16 and/or sgps 17, the configuration and shape(s) of said mgps 16 and sgps 17, the gap or spacing between rotating ring 15 and stationary ring 19, and the gap or spacing between of said mgps 16 and sgps 17.

Still referring to FIG. 3, in a preferred embodiment a pipe segment 18 is disposed within said housing 10. Said pipe segment 18 can be strategically positioned to direct the fluid entering said housing 10 to flow generally toward mgps 16 and sgps 17, while preventing fluid from flowing around said components. In a preferred embodiment, an electric or other motor is not coupled directly to rotating ring 15—thus, in the event of a failure of a mechanical seal or other component, said electric or other motor is not seriously damaged or destroyed.

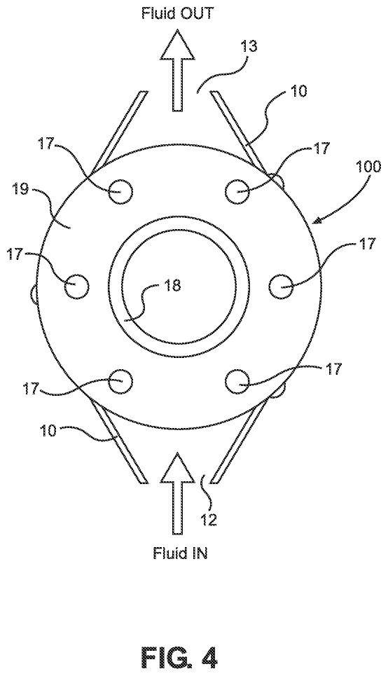

FIG. 4 depicts an end view of the fluid conditioning apparatus 100 of the present invention. In a preferred embodiment, said fluid conditioning apparatus 100 comprising a housing 10, fluid inlet 12, fluid outlet 13 and stationary ring 19. Stationary ring 19 has a plurality of sgps 17 extending from said stationary ring 19. As depicted in FIG. 4, said sgps 17 can disposed around the circumference of said stationary ring 19 in spaced relationship; the number and positioning of said sgps 17 can be selectively adjusted.

Pipe segment 18 can be selectively positioned between fluid inlet 12 and fluid outlet 13 in order to form a fluid flow path through said inner chamber of said reactor (typically a circumference path), but not through the middle of said inner chamber of said housing wherein fluid treatment action can be bypassed. No shearing or cavitation occurs, as the geometric shapes do not shear the fluid. Further, the reactor housing and other components do not degrade from cavitation.

In a preferred embodiment, a plurality of posts (such as screws) or other protrusions 50 extend into the inner chamber 11 of the reactor housing 10 at desired positions around the outer circumference of said rotating ring 15. Said protrusions 50 serve to center said rotating ring 15, so that pump drive shaft 14 connected to said rotating ring 15 can be removed from said rotating ring 15, while said rotating ring 15 itself remains centered within said inner chamber 11 of said housing 10.

Additionally, a mechanical fluid pressure seal is typically situated internally or externally relative fluid conditioning apparatus 100. Said mechanical fluid pressure seal can be selectively removed from outside of housing 10, so that said housing 10 does not need to be opened in order to access inner chamber 11 of housing 10. Furthermore, in a preferred embodiment, said reactor housing 10 can be welded using stainless steel that cannot be easily cut with a torch. Alternatively, stainless steel mechanical fasteners can be used to seal said housing 10, thereby requiring specialized tool(s) to access said inner chamber 11 of said housing 10.

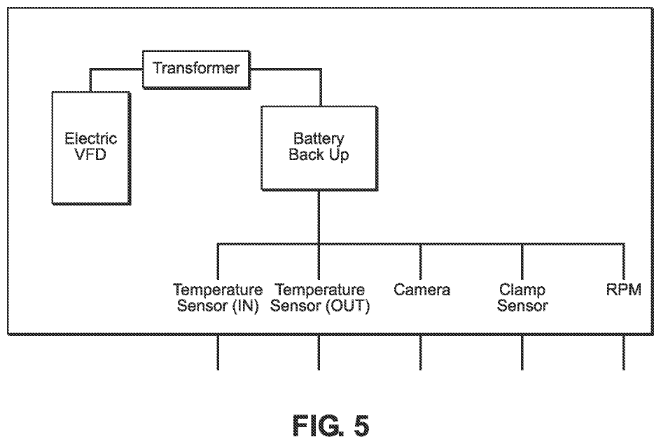

FIG. 5 depicts a schematic view of a control system for the fluid conditioning apparatus 100 of the present invention. At least one camera and sensors can be strategically placed to detect theft, as well as sensors to selectively measure desired variables and reactor performance (such as, for example, temperature inside and outside of the reactor housing, rpm, and other variables). Measured data can be transmitted to distant location(s), such as an office for real-time monitoring of the performance of fluid conditioning apparatus 100. Such monitoring, together with monitoring of an active mud system, can be used to selectively adjust the device, while also alerting personnel when said fluid conditioning apparatus 100 requires maintenance and/or replacement.

The present invention reduces or eliminates surface tension in drilling mud, allowing ultrafine solids to clump together and be removed so that a conventional centrifuge or other solids removal device can remove them without requiring dilution, a major achievement in the reduction of cost and waste to the environment.

In oil based muds, with a portion or percentage being water and a portion being oil (a typical oil based mud is 20% oil and 80% oil) an emulsifier is frequently added to allow the two components to mix. Although some emulsifiers can break down some of the surface tension and allows the components to mix; however, the present invention significantly reduces surface tension and, thus, works better on oil based muds, with much less emulsifier needed.

In operation, drilling mud is pumped through fluid conditioning apparatus 100 of the present invention at a variable flow rate depending upon job parameters and/or other factors. Electrical energy from a variable speed electric motor(s) can be transferred to drive shaft 14; if desired, a variable frequency drive package can be utilized.

Said fluid conditioning apparatus 100 mixes the drilling mud and chemical additives at a very high rate. Temperature and other desired measurements can be taken at or near fluid inlet 12, fluid outlet 13 and/or other locations of said housing 10 to determine performance of said fluid conditioning apparatus 100 including, without limitation, efficiency of fluid mixing without shearing or degrading the solids. The chemicals and/or other additives in the drilling mud base fluid are mixed to nearly one hundred percent (100%) yield in the first pass, as opposed to conventional mixing operations where it takes two or three passes through a drill bit in order to shear chemicals.

In accordance with the present invention, drilling fluid from one or more desired locations within a rig's active system (including, without limitation, mud mixing tank) is pumped into the fluid inlet of fluid conditioning apparatus 100. After being treated by said fluid conditioning apparatus 100, drilling fluid effluent flowing out of said fluid conditioning apparatus 100 can be directed back into said active mud system at a desired location.

Benefits of the fluid conditioning apparatus 100 of the present invention include, without limitation, the following:
Significantly save rig time per well
Lowers mud costs
Use significantly less emulsifiers and expensive chemicals
Substantially improves mud properties without chemicals
Increases electrical stability (by up to 4 to 5 times) on new mud
Increases yield point (by at least 2 times) while lowering plastic viscosity
Improves solids removal through centrifuges, including ultra-fines
Lowers equivalent circulating density
Lowers loss circulation risk
Improves hole cleaning characteristics
Stabilizes emulsion when not circulating
Heats muds if desired
Cleans up and reconditions oil based mud in tanks
Removes hydrogen sulfide and/or other impurities from mud
Homogenizes and removes fish eyes while leaving polymer chains intact
Cleans up dirty water and removes oil without chemicals

The present invention is environmentally beneficial and greatly reduces negative environmental effects associated with drilling operations. Because of the improved fluid characteristics generated by the present invention, less dilution of base drilling fluid is required. As a result, significantly less drilling mud volume must be disposed of as waste into the environment. As such, the present invention improves environmental impact of drilling operations.

The present invention can be used in virtually any application wherein improved fluid properties and characteristics are desired. One such application is the drilling of oil and gas wells into the earth's crust. Although the present invention is described in connection with drilling operations, this description is illustrative only and should not be construed as limiting in any manner. Put another way, the present invention can be beneficially employed in any number of different applications or industries.

Unlike other conventional attempts to solve this problem, the present invention does not shear the chemical solids into ultra-fines. In drilling mud it is disadvantageous to shear solids into ultra-fines, as ultra-fines require significantly more fluid dilution and resulting chemicals to treat the ultra-fines and maintain desired fluid properties in the drilling mud. Many such conventional devices utilize cavitation or energy waves in the fluid to cause the mixing; however, this action pulverizes the solids into ultra-fines which can have negative impact on drilling mud.

The present invention can employ different mechanical seal designs, different enclosure designs, different protrusions, different geometries in a housing, or in a large pipe with fluid flowing through it. The present invention can be in a trough or tank. Further, the present invention can be driven by different power sources including, without limitation, electric motors, hydraulic motors and/or pneumatic motors. The present invention can be used on many different fluids other than drilling mud.

Further, unlike other conventional devices, the present invention can work with heated drilling mud; however, such heating is not required for the present invention to properly function. As such, in applications where heated mud is not desirable (including, without limitation, where coolers are utilized), the present invention can mix aggressively without significant heating of the mud. The present invention can vary the surface speed of the geometric protrusions, the number and size of said protrusions, and the flow rate of fluid flowing past said protrusions.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. An apparatus for conditioning drilling fluid comprising:
a) a housing defining an inner chamber;
b) a fluid inlet extending into said inner chamber;
c) a fluid outlet extending out of said inner chamber;
d) a stationary ring disposed between said fluid inlet and said fluid outlet, and having an inner surface and an outer surface, wherein said stationary ring has a plurality of shaped protrusions extending from said inner surface of said stationary ring;
e) a movable ring disposed between said fluid inlet and said fluid outlet, and having an inner surface and an outer surface, wherein said movable ring is oriented substantially parallel to said stationary ring, and having a plurality of shaped protrusions extending from said inner surface of said movable ring; and
f) a drive shaft operationally attached to said movable ring configured to impart torque force to said movable ring.

2. The apparatus of claim 1, further comprising a pipe segment disposed between said plurality of shaped protrusions of said stationary ring.

3. The apparatus of claim 2, wherein said pipe segment directs drilling fluid flow toward said plurality of shaped protrusions extending from said inner surface of said stationary ring and said plurality of shaped protrusions extending from said inner surface of said movable ring.

4. The apparatus of claim 1, further comprising a motor operationally attached to said drive shaft.

5. The apparatus of claim 1, wherein said housing is installed within the active mud system of a drilling rig.

6. The apparatus of claim 5, wherein drilling fluid is diverted from said active mud system and directed into said fluid inlet.

7. The apparatus of claim 6, wherein drilling fluid effluent from said fluid outlet is directed into said active mud system.

8. The apparatus of claim 1, wherein no cavitation or shearing of drilling fluid occurs within said housing.

9. The apparatus of claim 1, wherein surface tension of drilling fluids is reduced, allowing ultrafine solids to clump together and be removed by a centrifuge or other solids removal device.

10. The apparatus of claim 9, wherein said ultrafine solids can be removed without requiring dilution of said drilling fluids.

11. A method for conditioning drilling fluids comprising:
a) providing a fluid conditioning apparatus comprising:
i) a housing defining an inner chamber;
ii) a fluid inlet extending into said inner chamber;
iii) a fluid outlet extending out of said inner chamber;
iv) a stationary ring disposed between said fluid inlet and said fluid outlet, and having an inner surface and an outer surface, wherein said stationary ring has a plurality of shaped protrusions extending from said inner surface of said stationary ring;
v) a movable ring disposed between said fluid inlet and said fluid outlet, and having an inner surface and an outer surface, wherein said movable ring is oriented substantially parallel to said stationary ring, and having a plurality of shaped protrusions extending from said inner surface of said movable ring; and
vi) a drive shaft operationally attached to said movable ring configured to impart torque force to said movable ring.
b) pumping drilling fluid from an active mud system of a drilling rig into said fluid inlet; and
c) returning drilling fluid from said fluid outlet into said active mud system.

12. The method of claim 11, wherein said fluid conditioning apparatus further comprises a pipe segment disposed between said plurality of shaped protrusions of said stationary ring.

13. The method of claim 12, wherein said pipe segment directs fluid flow toward said plurality of shaped protrusions extending from said inner surface of said stationary ring and said plurality of shaped protrusions extending from said inner surface of said movable ring.

14. The method of claim 11, wherein said fluid conditioning apparatus further compises a motor operationally attached to said drive shaft.

15. The method of claim 11, wherein no cavitation or shearing of drilling fluid occurs within said housing.

16. The method of claim 11, wherein surface tension of drilling fluids is reduced, allowing ultrafine solids in said drilling fluid to clump together.

17. The method of claim 16, wherein said ultrafine solids leaving said fluid outlet are removed from said drilling fluid by a centrifuge or other solids removal device.

18. The method of claim 17, wherein said ultrafine solids can be removed from said drilling fluid without requiring dilution of said drilling fluid.

19. The method of claim 11, wherein the fluid properties of said drilling fluid can be controlled by adjusting the distance between said plurality of shaped protrusions extending from said inner surface of said stationary ring and said plurality of shaped protrusions extending from said inner surface of said movable ring.
